(19) United States
(12) Patent Application Publication
(10) Pub. No.: US 2018/0186394 A1
(43) Pub. Date: Jul. 5, 2018

(54) APPARATUS FOR MOVING DISPLAY RACKS AND METHOD OF USE

(71) Applicant: Aireago Corp., Bloomingburg, NY (US)

(72) Inventors: Gerard Joseph Lowney, Bloomingburg, NY (US); Steven Lowney, Bloomingburg, NY (US)

(73) Assignee: Aireago Corp., Bloomingburg, NY (US)

(21) Appl. No.: 15/513,976

(22) PCT Filed: Sep. 24, 2015
(86) PCT No.: PCT/US15/51873

§ 371 Date: Mar. 23, 2017

(51) Int. Cl. B62B 5/00; B62B 1/14

(52) U.S. Cl. CPC B62B 5/0089; B62B 5/04; B62B 1/14

(57) ABSTRACT

An apparatus for moving a display rack, merchandise table and/or merchandise fixture include a dolly device having a vertical member, a horizontal support member, at least one hook and two legs connected to wheels.

### RELATED APPLICATIONS

This application claims priority from provisional application Ser. No. 62/054,916 filed Sep. 24, 2014 and application Serial No. PCT/US2015/051,873 filed Sep. 24, 2015.

### FIELD OF INVENTION

The present invention relates to display racks and tables and more particularly to an apparatus for moving a display rack, such as a clothes rack, display tables, and merchandise fixtures.

### BACKGROUND OF THE INVENTION

Conventional clothes and display racks are known and are typically used for displaying clothing items in commercial or consumer settings, such as in a department store, clothing store, and in the garment sales trade. These display racks may be quite long and heavy, especially when full of clothes for display purposes.

Display racks are used to display not just clothes but also accessories. Other display racks are known such as shoe displays, handbag displays, hat displays and the like. The use of the term “display rack” includes all such displays (racks, tables, fixtures and otherwise) and others known to those in the art. For example, further displays include merchandise tables or merchandise fixtures which may be used to display all types of merchandise in a retail store or other commercial establishment. Each of these types of displays are heavy even when not adorned with merchandise.

Display racks used in commercial or consumer settings must be rigid and strong, especially those in which the clothes rack is extended in a longitudinal direction, such as the conventional clothes rack used in a department store. Some conventional clothes racks may have a length exceeding 75 inches, or longer. Conventional display racks must be strong to support the clothes or other displayed items extending over such a length of 48 inches or greater. The display rack is typically comprised of a metal such as steel and thus are very heavy. In addition to being required to support the weight of the clothes or other displayed items, the display rack must be heavy so as to be stable and not easily moved when the consumer is removing a specific displayed item or even falling into the display rack itself. Further, when shopping with children it is quite common for the children to run into the middle open section of the display rack and be surrounded by clothes or other displayed items, as if in a cave of clothes. The child or children will move aside the displayed items and sometimes even hang on the bar used to hold hangers for the clothes or other displayed items. Thus the display rack is typically long and heavy and very hard to move, for safety and stability purposes.

While such strength and weight is needed for the characteristics described above, they are impediments when the store manager wishes to relocate a display rack, especially a display rack which has displayed items thereon. The conventional display rack has legs which are not movable and are set to be stable on the floor. The legs of the display rack are configured to anchor the display rack when in use. Thus the display rack is typically moved via brute force by a number of persons pulling and pushing together to move the heavy display rack. Such movement requires a large number of persons engaged in a coordinated action. Further, such movement commonly results in damaged floors where the legs, or other support means, of the display rack are dragged across the floor. Damage may include scraped floors, divots, holes and other damage. Such methods to move a display rack may also result in harm or injury to the persons moving the display rack. Injuries may include bumps, bruises, strained muscles, broken bones, and even injury to extremities such as the leg of a display rack crushing a person's toe.

In one example, retail staff may presently transport clothing racks around within the stores with the racks full of merchandise. This greatly adds to the difficulty and weight of the racks with some racks weighing up to 400 lbs. This makes transportation extremely time consuming and difficult. These racks are often dragged from location to location, which often results in damage to the retail locations floor.

While certain display racks have been developed including wheels on the legs or support means, such display racks are typically limited in length and the wheels result in less stability when the display rack, is stagnant. Thus the sturdiness and stability needed to support the displayed items and to prevent movement when a customer is removing displayed items, along with the aforementioned children playing in or on the display racks, contradicts the use of wheels or other moveable supports on a display rack itself.

Certain dollies or devices are known which may mechanically lift a display rack but such devices are time consuming to use, expensive, require an energy source such as electricity or gasoline, large to store when not in use, and/or require multiple persons to lift the display rack manually onto such devices.

Thus, a need exists for an apparatus which may be connected to a display rack for the purpose of moving the display rack, including when the display rack is partially or full of displayed items. A further need exists for an apparatus to move a display rack while reducing or eliminating damage to the surface over which the display rack is moved. Another need exists for an apparatus to move a display rack while reducing or eliminating injury to the person engaged in moving the display rack. A further need exists for an apparatus to move a display rack which is easy to store and does not take up space while in storage, which storage space is typically at a premium in a retail store or elsewhere since merchandise for sale takes priority. A further need exists for a cheaper apparatus to move a dis play rack.

Merchandise fixtures are also rigid and heavy so as to be sturdy to support the merchandise thereon and to prevent movement of the fixture, such as but not including a table or display or hanging fixture, and merchandise when bumped into by a person, such as a shopper. Moving a merchandise fixture conventionally is done by a plurality of persons physically pushing and pulling the table or fixture, resulting in damaged floors and strains, even possible injury, to the persons. A need exists for an apparatus which may be connected to a merchandise table or merchandise fixture for the purpose of moving the merchandise table or merchandise fixture. A further need exists for an apparatus to move a merchandise table or merchandise fixture while reducing or eliminating damage to the surface over which the merchandise table is moved. Another need exists for an apparatus to move a merchandise table or merchandise fixture while reducing or eliminating injury to the person engaged in moving the merchandise table or merchandise fixture.

Other advantages of the present invention will become apparent from the following description and appended claims.

### BRIEF DESCRIPTION OF THE DRAWINGS

FIG. 1 is a perspective vies one embodiment of the apparatus of the present invention.

FIG. 2 is a top plan view of an embodiment of the apparatus of the present invention.

FIG. 3 is a side view of an embodiment of the apparatus of the present invention.

FIG. 4 is another embodiment of the apparatus of the present invention with a telescoping vertical member and a pair of bottom leg supports.

FIG. 5 is another embodiment of the apparatus of the present invention with a telescoping vertical member.

FIG. 6 is front view of another embodiment of the apparatus of the present invention including a braking means on the wheels.

FIG. 7 is side view of another embodiment of the apparatus of the present invention including a braking means on the wheels.

FIGS. 8A and 8B are an embodiment of the method of use of the apparatus of the present invention in use when moving a display rack wherein the display rack has one side with wheels and the other without wheels.

### DETAILED DESCRIPTION OF THE PREFERRED EMBODIMENTS

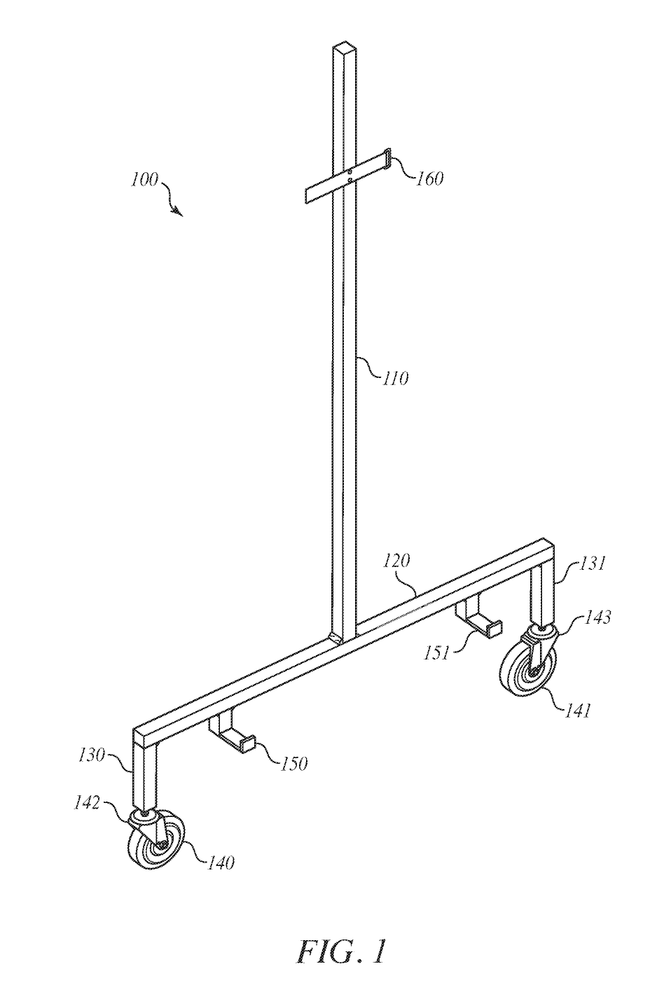

Reference will now be made to the drawings wherein like reference numerals identify similar structural features or aspects of the subject invention. For purposes of explanation and illustration, and not limitation, exemplary embodiments of a minimally invasive surgical assembly in accordance with the invention, or aspects thereof, are shown in FIGS. 1 through 8A and 8B. The inventive apparatus is a low cost, easy to manufacture, apparatus which can be used to move a display rack, merchandise table or merchandise fixture while reducing or eliminating damage to floor and injury to persons engaged in the moving actions.

FIG. 1 is a perspective view of one embodiment of the inventive apparatus 100. The apparatus 100 includes a pair of display rack rolling supports each having a frame with a vertical member 110 connected to a horizontal support member 120. The apparatus 100 may be a dolly.

In one embodiment of the inventive apparatus 100, the horizontal support member 120 has at least two vertical support members 130, 131. In this embodiment there are two legs 130, 131 (otherwise known as vertical support members) each of which is connected to a moving means, such as a wheel 140, 141. The moving means may include caster, wheels and the like. The moving means such as a pair of wheels as shown in FIG. 1, are connected to the legs 130, 131 by a hinge 142, 144 and a screw, nut or bolt (not shown). The moving means is used to move the apparatus 100 alone or when already connected to the display rack to move the connected display rack from one location to another location and should be sufficiently strong to support the display rack and to move over rough surfaces such as warehouses, city streets and sidewalks if needed, for instance, in the garment industry section of Manhattan.

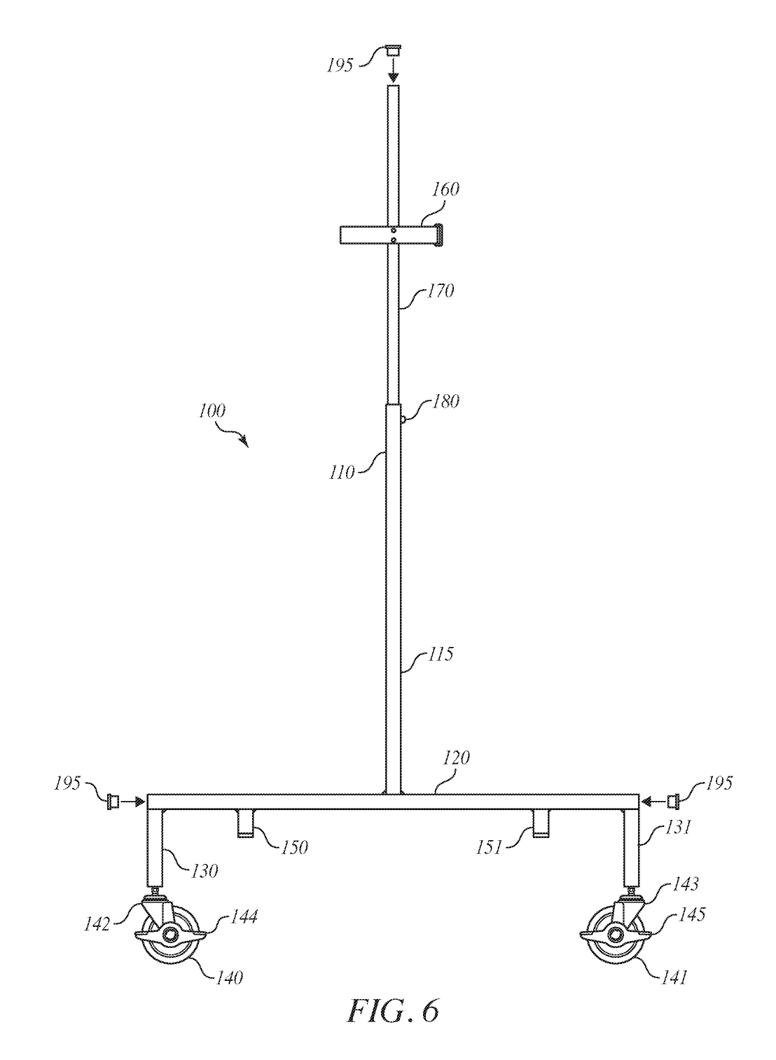

The caster is conventional, such as that of U.S. Pat. No. 5,745,951 whose contents are incorporated by reference. The caster 142, 143 may include a caster assembly that has a caster fork, a caster wheel 140, 141 attached to the caster fork, and a mounting shaft attached to a caster fork. The mounting shaft is shaped and sized to extend through the aperture in a frame leg when the caster assembly is in an installed position wherein the caster is adjacent to a bottom side of the frame leg and an intermediate portion of the mounting shaft is adjacent to a top side of the frame leg. The mounting shaft has an generally flat blocking surface extending along a portion of the shaft such that the blocking surface is adjacent to the aperture in the frame leg when the caster is in the installed position. The wheels 140, 141 may have a braking means 144, 145 attached such as shown in FIGS. 6 through 8A. In one embodiment the braking means includes a locking washer which is removably connected to the mounting shaft and is mountable to the frame leg. The locking washer has a shaft aperture that receives the mounting shaft therein, and an engagement portion defines a portion of the shaft aperture. The blocking surface is removably positioned immediately adjacent to the engagement portion so as to engage the engagement portion and prevent rotational movement of the mounting shaft relative to the locking washer and relative to the frame leg when the caster is in the installed position. The locking washer retains the mounting shaft in a selected angular orientation relative to the frame leg aligned with a primary intended direction of travel, thereby providing directional control of the frame structure.

The horizontal support member 120 of the inventive apparatus 100 includes at least one, preferably at least two, connecting means capable of connecting to or supporting a lower portion of the display rack when the apparatus is in use to move the display rack. The connecting means 150 may be a hook, Velcro metal lever or the like. Depending on the length and weight of the display rack, merchandise table or merchandise fixture being moved by the inventive apparatus 100, the connecting means 150 may include two or more means to support the lifted display rack when in use. In this embodiment of the invention 100 the connecting means are two hooks 150, 151 having a recess area to connect to and support the bottom horizontal portion of a display rack. In use a pair of apparatus is employed with each being connected to opposite ends of the display rack such that the display rack is lifted off the floor and moved via the wheels 140, 141 on each of the pair of apparatus 100.

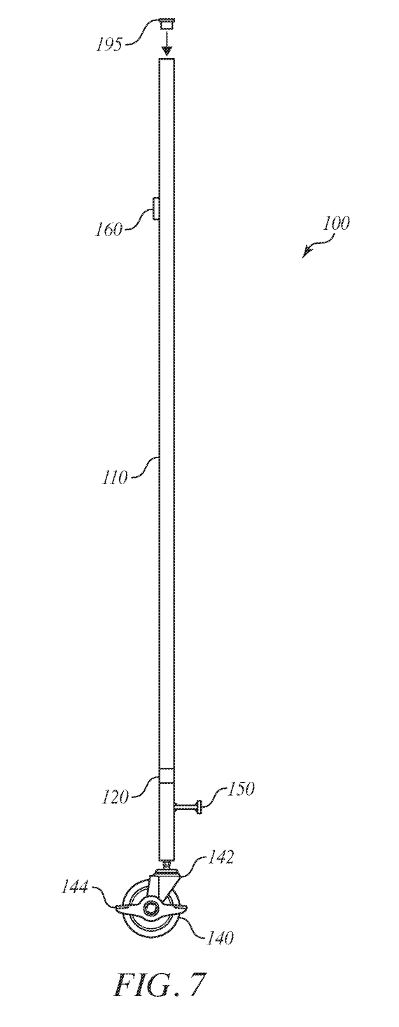

As shown in FIGS. 6 and 7, the connecting means are two hooks 150, 151 which have a flat surface parallel to the vertical support member 110 and a hook above and below. This provides a flat surface on the front portion of the hooks 150, 151 so as to prevent injury to the user when the apparatus 100 is in use and connected to the display rack.

The apparatus 100 may be comprised of metal or rigid plastics and polymers, aluminum, carbon and the like. The apparatus 100 should be comprised of a material sufficient to support a full display rack, for instance up to about 300 pounds. With additional support and material an apparatus 100 can support up to 1,000 pounds. The apparatus is preferably made of metal more preferably either steel or aluminum.

The vertical member 110 should be of sufficient height to allow the user to easily grasp it so as to move the connected and lifted display rack. The vertical member 110 may be of a height from about 20 inches to about 80 inches, preferably from about 40 inches to about 60 inches. In a preferred embodiment the vertical member 110 is at least 24 inches.

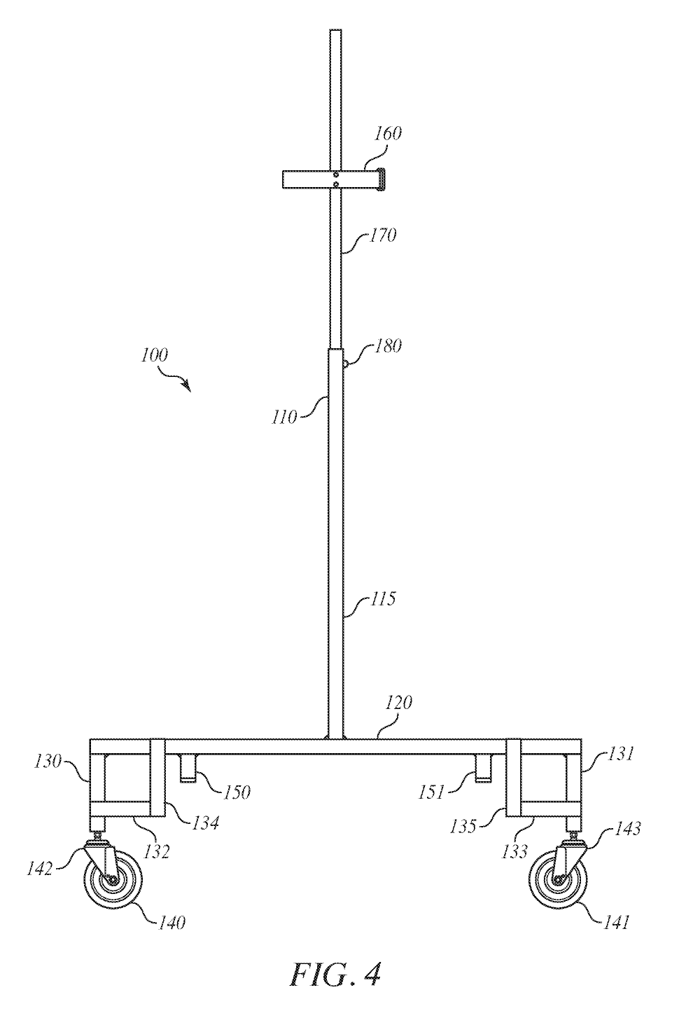

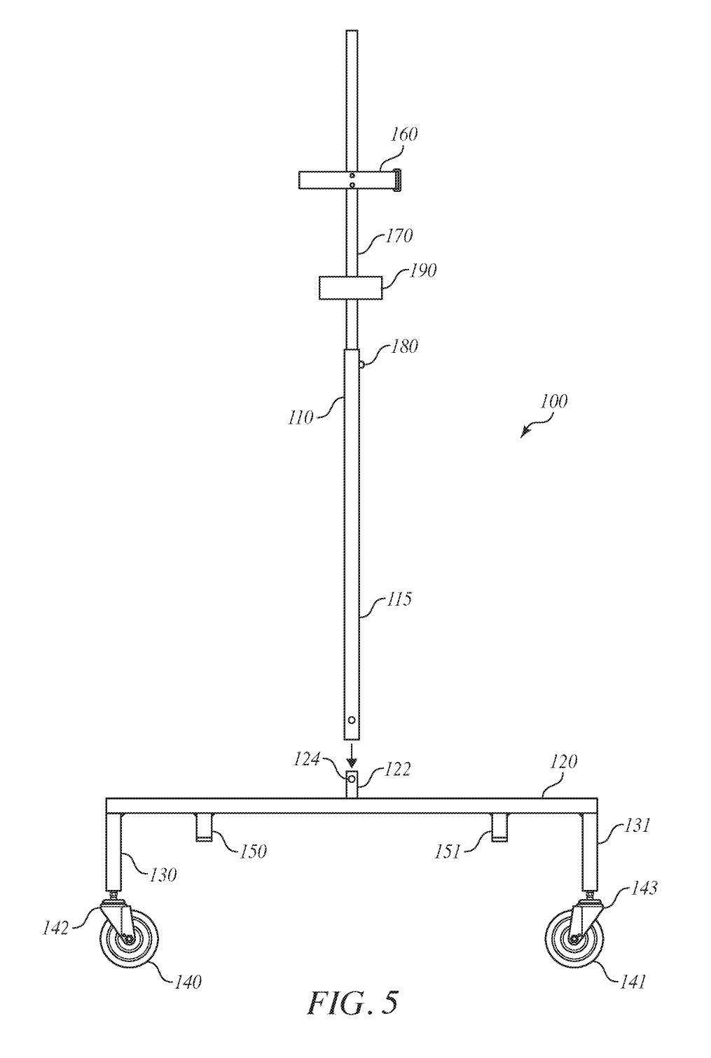

Optionally vertical member 110 may be telescoping so that the height may be adjusted by the user depending on the height of the display rack and/or the height of the person moving the display rack via the inventive apparatus 100. FIGS. 4 and 5 shows the telescoping feature of the vertical member 110 wherein the vertical member is comprised of a base member 122 extending from the horizontal support member 120, a vertical extension 115 and a telescoping vertical member 170. The base member 122 is connected to the vertical extension 115 via a connecting means 124 such as a pin, screw, nail, spring, nut, twist lock and the like within an aperture of the distal end of the extension member 115. The telescoping vertical member 170 is connected to the vertical extension 115 via a connecting means 180 such as a pin, screw, nail, spring, nut, twist lock and the like within an aperture of the proximal end of the extension member 115.

The vertical member 110 may also optionally include a means to connect an upper portion of the display rack to the apparatus 100. For instance, the connecting means may be a strap 160, such as a Velcro strap, a rope strap, a fabric strap, a bungee cord or any elastic or pliable strap which may be tied or secured to an upper position of the display rack. The strap 160 further secures the display rack to the apparatus 100 when in use so that the display rack remains upright and connected to the apparatus 100.

The vertical member 10 may also optionally include a pulling means which may be the connecting means 160 or may be some other handle or pulling means 190. In other embodiments the pulling means ay be a handle 190 as shown in FIG. 5 for the user to pull the apparatus 100. The handle 190 may be comprised of metal, rigid plastic or polymers, wood or fabric.

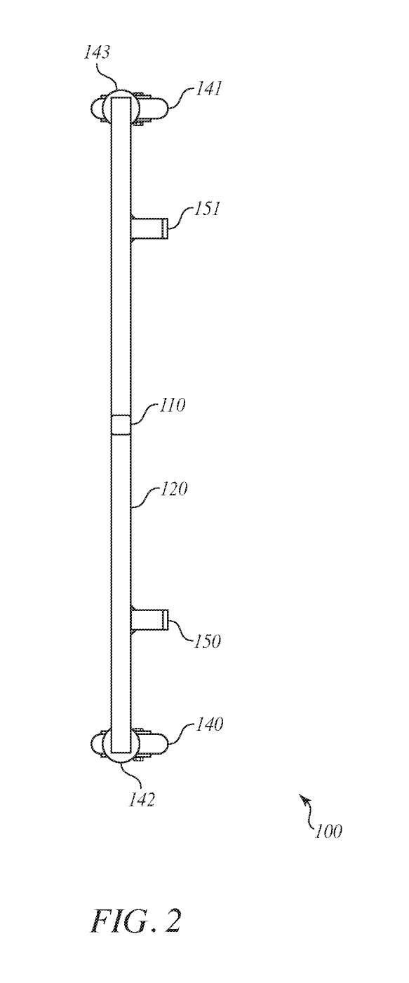

FIG. 2 shows the top view of the inventive apparatus 100. The hooks 150, 151 are shown to protrude from the horizontal support member 120 so that a display rack may be lifted and connected to the apparatus 100. This embodiment does not include a handle or Velcro strap.

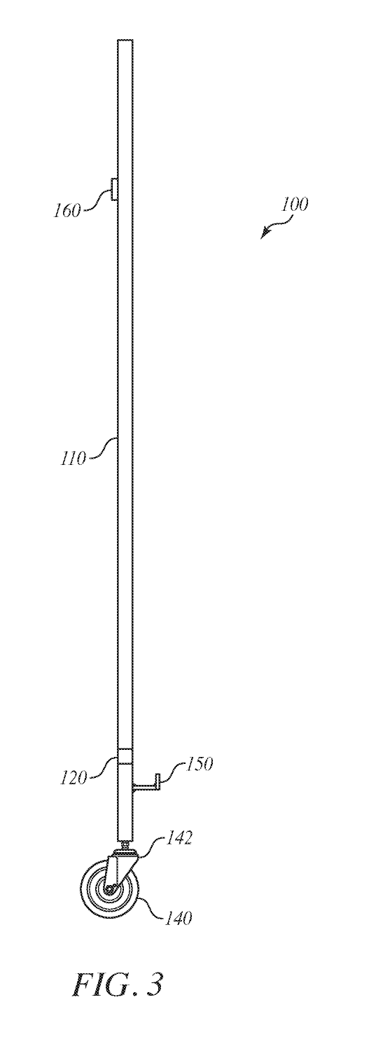

A side view of the inventive apparatus 100 is shown in FIG. 3 where yet another view of one of the protruding hooks 150 is seen. In this embodiment the connecting means strap 160 is shown as protruding in the opposite axially direction as the hook 150, though other positions of the connecting means strap 160 may be used in other embodiments of the inventive apparatus 100 including at other locations in an upward or downward direction of the vertical member 110. FIG. 7 shows another embodiment of the inventive apparatus 100 with a view of one of the alternate embodiment of the protruding hooks 150 is seen. In this embodiment the connecting means strap 160 is shown as protruding in the opposite axially direction as the hook 150, though other positions of the connecting means strap 160 may be used in other embodiments of the inventive apparatus 100 including at other locations in an upward or downward direction of the vertical member 110. In FIG. 7 no separate handle 190 is shown but the connecting means strap 160 such as a Velcro strap could be used to pull the apparatus 100.

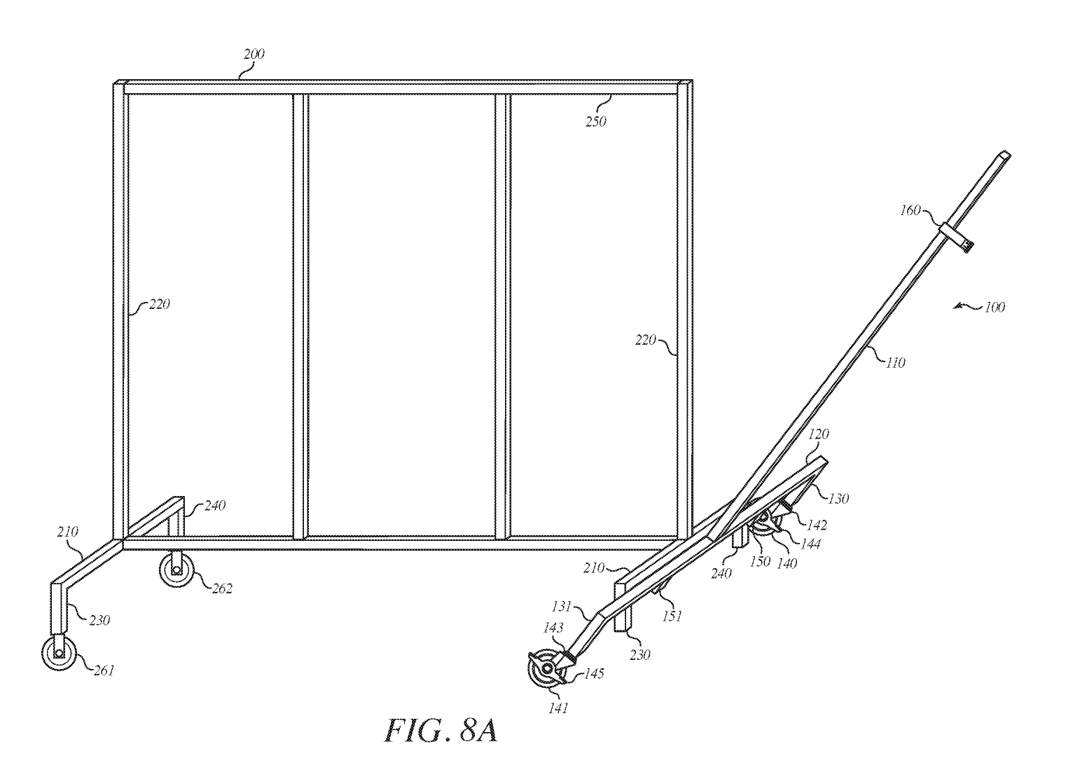

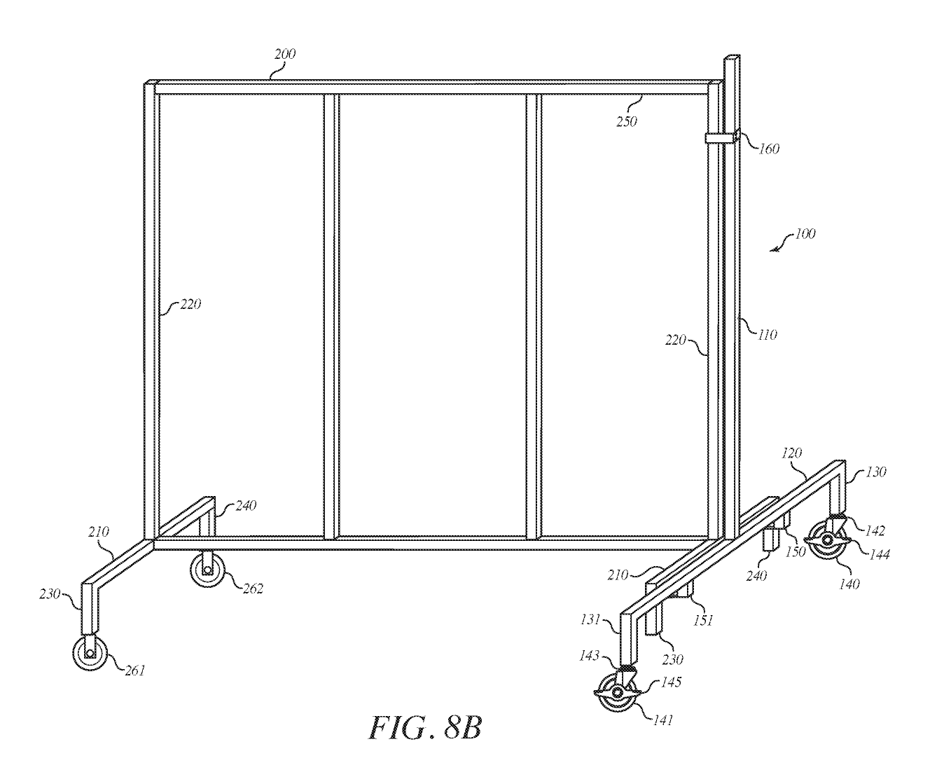

In use, at least one and preferably a pair of the inventive apparatus 100, are rolled to the location of the display rack. The method of use includes the step of a user placing the inventive apparatus 100 next to one end of the display rack with the hooks 150, 151 protruding toward the display rack. The user angles the apparatus as shown in FIG. 8A such that the horizontal support member 120 and hooks 150, 151 are located below the horizontal support element 210 of the display rack 200. The user then pushes the lifts the display vertical member 110 upward to a 90 degree location and this movement lifts the display rack 200 up and places the bottom horizontal support element 210 of the display rack onto the hooks 150, 151. If the optional connecting means such as a strap 190 is being used it is placed around the vertical element 220 of the display rack 200 for additional support and securing of the display rack 200 on the inventive apparatus 100. If a pair of the inventive apparatus 100 is being used the user moves the second apparatus 100 to the opposite end of the display rack and repeats the angling, lifting and securing process. The display rack 200 is thus lifted and supported by one apparatus 100 as shown in FIG. 8B wherein the display rack has one side with a pair of wheels 261, 262 and the other side without wheels with the legs 230, 240 of the display rack 200 lifted off of the floor. If the display rack 200 only has legs and no wheels then a pair of apparatus 100 may be used, one on each side of the display rack 200 lifting and supporting the pair of bottom horizontal support elements 210. The display rack 200 may include merchandise being displayed therein, for example with clothes hanging from horizontal member 250 user or users can now move the display rack without damaging the floor as the legs 230, 240 of the display rack are lifted. Further, the user or users need not to physically lift the display rack 200 as the angling below and pushing upward of the vertical member 110 lifts the display rack 200 off of the floor with much less force and strain to the user. The user can more easily move the lifted and supported display rack due to the wheels 140, 141 of the apparatus versus physically pushing and pulling the display rack 200. Thus, the inventive apparatus 100 in use alleviates physical strain on employees by the weight of the racks by elevating and supporting the display rack during transport.

FIG. 8B shows the inventive apparatus 100 in use to lift and move a to merchandise table. Depending on the height of the legs of the merchandise table, the user can either employ the method of use described above for lifting the display rack wherein the user angles the hooks 150, 151 of the inventive apparatus 100 under a horizontal member of the merchandise table and pushes the vertical member 110 of the inventive apparatus 100 to lift and merchandise table, or in an alternative method of use the user lifts and moves the merchandise table at a 90 degree angle and then places a leg of the merchandise table on the hooks 150, 151 of the inventive apparatus 100 and may optionally use the strap 190 to further secure the merchandise table on the inventive apparatus 100 prior to movement. Other methods to use the inventive apparatus 100 to move a merchandise table may be employed. Further, the inventive apparatus 100 may be used to move all types of merchandise fixtures.

In yet another embodiment of the present invention as shown in FIG. 4 the horizontal support member 120 of the inventive apparatus 100 includes at least one, preferably at least two, bottom vertical support means 134, 135 to support and stabilize the bottom legs 230, 240 of the display rack 200. The bottom vertical support means 134, 135 stabilize the bottom legs 230, 240 of the display rack 200 from moving side to side horizontally and hitting the two vertical support members 130, 131 of the inventive apparatus 100. Thus in use the bottom legs 230, 240 of the display rack 200 are either in contact with the bottom vertical support means 134, 135 or are capable of having contact bottom vertical support means 134, 135 as the inventive apparatus 100 moves the display rack 200. In FIG. 4 two further support means are included, which are optional, as bottom horizontal support means 132, 133. These optional bottom horizontal support means 132, 133 are support for the bottom vertical support means 134, 135 and may further stabilize the display rack 200 when connected to the inventive apparatus 100 and when in use and moving.

FIGS. 1 through 8 show various embodiments of the inventive apparatus 100, but others are contemplated based on the configuration of the display rack or merchandise table or merchandise fixture. Certain display racks may have more than one vertical member one on end and thus the apparatus 100 may be adjusted in regard to the vertical member 110 configuration and even, additional vertical members may be added, spaced apart from each other to mirror or compliment the location or configuration of the display rack vertical members. Similarly the horizontal support member 120 may be reconfigured to mirror or compliment the location or configuration of the display rack horizontal member or members

The inventive apparatus 100 is also easy to store. The inventive apparatus 100 has a relatively small footprint in that the width of the apparatus is a combination of the width of the vertical member 110, horizontal member 120, wheels 140, 141 and hooks 150, 151. Notably the hooks 150, 151 may be used to hang the inventive apparatus 100 when in storage thus further reducing the footprint of the inventive apparatus 100. The inventive apparatus 100 may be hung upside down with the hooks 150, 151 resting on top of a storage vertical frame. Thus the inventive apparatus 100 is easy to store when not in use and not bulky compared to conventional moving apparatus.

The following benefits, structure, and advantages are also contemplated by the present invention: reduced or eliminated damage to floors and other surfaces due to the movement of the display rack, reduced strain and physical exertion by the user when moving the display rack, easier handling of display racks by the user, and other benefits. The inventive apparatus 100 is also easier and cheaper to manufacture than conventional display rack movers and has the advantage of not requiring an energy source such as electricity, batteries or gasoline to lift and move the display rack(s). Further, the inventive apparatus quickly lifts and moves the display rack with minimum training of the user.

The apparatus and method of use of the present invention, as described above and shown in the drawings, provide for movement of display racks with superior properties including ease of use and operation. While the apparatus and methods of the subject invention have been shown and described with reference to preferred embodiments, those skilled in the art will readily appreciate that changes and/or modifications may be made thereto without departing from the spirit and scope of the subject invention.

What is claimed is:

1. An apparatus for moving a display rack, comprising:
(a) a vertical member; and
(b) a horizontal support member having at least one connecting means capable of connection to and lifting of the display rack and at least two moving means, wherein the horizontal member is connected to the vertical member.

2. The apparatus according to claim 1 wherein the connecting means is at least one hook configured to lift the display rack off a floor.

3. The apparatus according to claim 1 wherein the connecting means is at least two hooks at a distance from one another and configured to lift the display rack off a floor.

4. The apparatus according to claim 1 wherein the two moving means are wheels.

5. The apparatus according to claim 4 further comprising a braking means connected to the wheels.

6. The apparatus according to claim 2 wherein the connecting means further comprises a strap located on the upper portion of the vertical member.

7. The apparatus according to claim 1 further comprising a vertical support member connected to the horizontal support member which is capable of contact with a leg of the display rack.

8. An apparatus for moving a display rack, comprising:
at least one display rack nailing support that includes:
a plurality of casters;
a frame having a plurality of frame legs, a horizontal support member connecting the plurality of frame legs, at least one vertical member extending upright from the horizontal support member, a plurality of hooks projecting from said horizontal support member from a same side of said horizontal support member, each hook of said plurality of hooks defining a respective recess; and
means for securing the plurality of casters to the plurality of frame legs in a manner that elevates an entirety of the frame off a ground upon which rests the plurality of casters, the casters being arranged to effect rolling motion in response to a manual force exerted on the frame so as to move the frame in a direction of the manual force relative to the ground.

9. The apparatus of claim 8, wherein the at least one display rack support includes a plurality of display rack supports each substantially identical in configuration to each other, said plurality of display rack supports including two display rack supports, said two display rack supports being arranged substantially parallel to each other with said plurality of hooks of each of said two display rack supports projecting outwardly between said two display rack supports.

10. The apparatus of claim 9, further comprising:
a display rack having a pair of horizontal support elements that extend substantially parallel to each other with one of said horizontal support elements fit into said plurality of hooks of one of said two display rack supports and a remaining one of said pair of horizontal support elements fit into said plurality of hooks of a remaining one of said two display rack supports.

11. The apparatus of claim 8, further comprising:
connecting means for connecting the vertical member to a display rack, said connecting means being selected from a group consisting of a strap, a cord, a band, a string, and a rope.

12. The apparatus of claim 8, further comprising:
a pair of vertical support members connected to the horizontal support member of the frame, said vertical support members being capable of having contact with a leg of the display rack when the display rack is connected to the one display rack rolling support.

13. The apparatus of claim 8, further comprising:
a display rack having a pair of horizontal elements that extend substantially parallel to each other with one of said horizontal support elements fit into said plurality of hooks of one of said two display rack supports and a remaining one of said pair of horizontal support elements fit into said plurality of hooks of a remaining one of said two display rack supports;
connecting means for connecting the vertical member to the display rack, said connecting means being selected from a group consisting of a strap, a cord, a band, a string, and a rope, said connecting means of each of said two display racks fastening together said display rack to said two display rack supports.

14. The apparatus of claim 8, wherein said vertical member includes a plurality of components of different diameter arranged to telescope with each other into any one of a plurality of relative positions.

15. A method of assembly an apparatus for moving a display rack, comprising the steps of:
positioning in an upright position relative to ground at least one display rack rolling support that includes:
a plurality of casters;
a frame having a plurality of frame legs, a horizontal support member connecting the plurality of frame legs, at least one vertical member extending uptight from the horizontal support member, a plurality of hooks projecting from said horizontal ember from a same side of said horizontal support member, each hook of said plurality of hooks defining a respective recess; and
means for securing the plurality of casters to the plurality of frame legs in a manner that elevates an entirety of the frame off a ground upon which rests the plurality of casters, the casters being arranged to effect rolling motion in response to a manual force exerted on the frame so as to move the frame in a direction of the manual force relative to the ground.

16. The method of assembly the apparatus of claim 15 wherein the positioning in an upright position relative to ground the at least one display rack support includes positioning in the upright position a plurality of the display rack supports each substantially identical in configuration to each other, said plurality of display rack supports including two display rack supports, said two display rack supports being arranged substantially parallel to each other with said plurality of hooks of each of said two display rack supports projecting outwardly between said two display rack supports.

17. The method of assembly of the apparatus of claim 15 further comprising:
arranging a display rack having a pair of horizontal support elements that extend substantially parallel to each other so that one of said horizontal support elements is placed to fit into said plurality of hooks of one of said two display rack supports and a remaining one of said pair of horizontal support elements is placed to fit into said plurality of hooks of a remaining one of said two display rack supports.

18. The method of assembly of the apparatus of claim 15, further comprising:
providing connecting means that connects the vertical member to a display rack, said connecting means being selected from a group consisting of a strap, a cord, a band, a string, and a rope.

19. The method of assembly of the apparatus of claim 15, further comprising:
providing a display rack having a pair of horizontal support elements that extend substantially parallel to each other and placing one of said horizontal support elements to fit into said plurality of hooks of one of said two display rack supports and placing a remaining one of said pair of horizontal support elements to fit into said plurality of hooks of a remaining one of said two display rack supports;
providing connecting means that connects the vertical member to the display rack, said connecting means being selected from a group consisting of a strap, a cord, a band, a string, and a rope, said connecting means of each of said two display racks fastening together said display rack to said two display rack supports.

20. The method of assembling the apparatus of claim 15, wherein said vertical member includes a plurality of components of different diameter ranged to telescope with each other into any one of a plurality of relative positions, further comprising:
telescoping the plurality of components into one of the plurality of relative positions.
